(19) United States
(12) Patent Application Publication
(10) Pub. No.: US 2025/0369641 A1
(43) Pub. Date: Dec. 4, 2025

(54) DEVICE AND METHOD FOR DISPLAYING SUBCOOLING DATA OF A REFRIGERATION CIRCUIT

(71) Applicant: Carrier Corporation, Palm Beach Gardens, FL (US)

(72) Inventors: Charles Cluff, Zionsville, IN (US); Everett Lumpkin, Galveston, IN (US)

(21) Appl. No.: 19/187,568

(22) Filed: Apr. 23, 2025

Related U.S. Application Data
(60) Provisional application No. 63/653,113, filed on May 29, 2024.

(51) Int. Cl. F24F 11/523; F24F 140/20; G09G 3/14; G09G 3/18

(52) U.S. Cl. CPC F24F 11/523; G09G 3/14; F24F 2140/20; G09G 3/18

(57) ABSTRACT

Described herein is a device for displaying subcooling data of a refrigeration circuit associated with an HVAC system. The device comprises a display module having a predefined display area configured to display at least two characters at a time, wherein the display module is configured to receive subcooling data of the refrigeration circuit and display the received subcooling data over the predefined display area in alphanumeric and/or string characters while scrolling or paging the data thereover in a predefined direction and at a predefined interval.

### CROSS-REFERENCE TO RELATED APPLICATION

This patent application claims the benefit of U.S. Provisional Patent Application No. 63/653,113, filed on May 29, 2024, which is incorporated by reference herein in its entirety.

### BACKGROUND

The subject disclosure relates to the field of refrigeration circuits and more particularly, to a device and a method for displaying subcooling data of a refrigeration circuit associated with an HVAC system.

### SUMMARY

Disclosed herein is a device for displaying subcooling data of a refrigeration circuit associated with an HVAC system. The device comprises a display module having a predefined display area configured to display at least two characters at a time, wherein the display module is configured to receive subcooling data of the refrigeration circuit and display the received subcooling data over the predefined display area in alphanumeric and/or string characters at a predefined interval.

In one or more embodiments, the subcooling data comprises one or more of a subcooling temperature of refrigerant within the refrigeration circuit, and a subcooling target temperature to be maintained in a vapor line of the refrigeration circuit.

In one or more embodiments, the predefined display area of the display module is configured to display two alphanumeric and/or string characters at a time.

In one or more embodiments, the device is configured to display two alphanumeric and/or string characters associated with the subcooling data over the predefined display area at a time while scrolling the data in a predefined direction and at the predefined interval.

In one or more embodiments, the device is configured to display two alphanumeric and/or string characters associated with the subcooling data over the predefined display area at a time while paging a series of the two characters of the data in a predefined direction at the predefined interval.

In one or more embodiments, the device is secured on an outdoor unit associated with the HVAC system.

In one or more embodiments, the device is secured on a thermostat associated with the HVAC system.

In one or more embodiments, the display module is configured to be operably connected to a charge-setting monitoring unit associated with the refrigeration circuit, wherein the charge-setting monitoring unit is configured to generate the subcooling data of the refrigeration circuit.

In one or more embodiments, the device is secured on the charge-setting monitoring unit.

In one or more embodiments, the display module is a dot-matrix display.

In one or more embodiments, the display module is a 5×7 dot-matrix display.

In one or more embodiments, the display module is selected from a group comprising a light-emitting diode (LED) based display, a liquid crystal display (LCD), and an e-ink display.

In one or more embodiments, the device further comprises a communication module configured to enable the device to establish a communication channel with the charge-setting monitoring unit or a thermostat associated with the HVAC system.

In one or more embodiments, the device further comprises a battery that provides electrical power to the device.

In one or more embodiments, the device is configured to be electrically connected to an external power source to supply electrical power to the device and/or charge the battery.

Also described herein is a method for displaying subcooling data of a refrigeration circuit associated with an HVAC system. The method comprises displaying, over a display module having a predefined display area capable of displaying at least two characters at a time, subcooling data of the refrigeration circuit in alphanumeric and/or string characters at a predefined interval.

In one or more embodiments, the subcooling data comprises one or more of a subcooling temperature of refrigerant within the refrigeration circuit, and a subcooling target temperature to be maintained in a vapor line of the refrigeration circuit.

In one or more embodiments, the method further comprises displaying, over the predefined display area, two alphanumeric and/or string characters associated with the subcooling data at a time while scrolling the data in a predefined direction and at the predefined interval.

In one or more embodiments, the method further comprises displaying, over the predefined display area, two alphanumeric and/or string characters associated with the subcooling data at a time while paging a series of the two characters of the data in a predefined direction at the predefined interval.

In one or more embodiments, the display module is secured on one or more of an outdoor unit, a thermostat, and a charge-setting monitoring unit associated with the HVAC system, wherein the display module is selected from a group comprising an LED based display, an LCD, an e-ink display, and a dot-matrix display.

The foregoing summary is illustrative only and is not intended to be in any way limiting. In addition to the illustrative aspects, embodiments, and features described above, further aspects, embodiments, features, and techniques of the invention will become more apparent from the following description taken in conjunction with the drawings.

### BRIEF DESCRIPTION OF THE DRAWINGS

The accompanying drawings are included to provide a further understanding of the subject disclosure of this invention and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A and 1B illustrate exemplary schematic representations of an embodiment of a device for displaying subcooling data of a refrigeration circuit associated with an HVAC system, in accordance with one or more embodiments of the subject disclosure.

FIGS. 1C and 1D illustrate exemplary schematic representations of another embodiment of the device for displaying the subcooling data of the refrigeration circuit associated with the HVAC system, in accordance with one or more embodiments of the subject disclosure.

FIG. 1E illustrates exemplary functional modules of the device of FIG. 1, in accordance with one or more embodiments of the subject disclosure.

FIG. 2 illustrates exemplary steps involved in a method for displaying subcooling data of a refrigeration circuit associated with an HVAC system, in accordance with one or more embodiments of the subject disclosure.

FIG. 3A illustrates an exemplary representation of the subcooling data being displayed and scrolled over the display area of the device, in accordance with one or more embodiments of the subject disclosure.

FIG. 3B illustrates an exemplary representation of the subcooling data being displayed and paged over the display area of the device, in accordance with one or more embodiments of the invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components described herein may be positioned in any desired orientation. Thus, the use of terms such as “above,” “below,” “upper,” “lower,” “first,” “second,” or other like terms to describe a spatial relationship between various components or to describe the spatial orientation of aspects of such components should be understood to describe a relative relationship between the components or a spatial orientation of aspects of such components.

HVAC systems are employed for maintaining indoor air quality and comfort in residential, commercial, and industrial buildings. These systems operate by circulating a refrigerant through a closed circuit, undergoing cycles of compression, condensation, expansion, and evaporation. The efficiency and effectiveness of HVAC system depend significantly on the charge (amount) of refrigerant within the system.

Traditionally, checking or adjusting the refrigerant charge in an HVAC system requires the use of gauges or display devices to display subcooling data of the refrigerant at various points in the system. Additionally, measuring the operating subcooling may help determine the efficiency of heat exchange in the condenser and to infer the correct refrigerant charge. However, the conventional approach presents several drawbacks.

For instance, attaching gauges to an HVAC system introduces the potential for contaminating the system. The process involves opening the system to connect the gauges, which may allow moisture, air, or other contaminants to enter. These contaminants may affect the performance of the refrigerant, lead to corrosion of the system components, and ultimately reduce the lifespan of the system. Further, even with careful handling, attaching and detaching gauges from the system is likely to release at least a small amount of refrigerant into the atmosphere.

Further, the use of traditional light-emitting diode (LED)-based display devices is limited to indicating low, correct, or overcharge conditions in the HVAC system. Such devices may fail to provide numeric indications giving a technician the ability to observe the subcooling data or charge-settings. Further, other display devices that may provide numeric indications are generally bulky, costly, and high-power-consuming, making them difficult to implement in HVAC systems.

Therefore, there is a need for a solution to accurately display subcooling data associated with the HVAC system in a simple, efficient, and cost-effective way, which may avoid the direct attachment of external components to the HVAC system, eliminate the potential for contamination, and prevent the release of refrigerants into the atmosphere, while ensuring accurate assessment and display of the system's refrigerant charge or subcooling data.

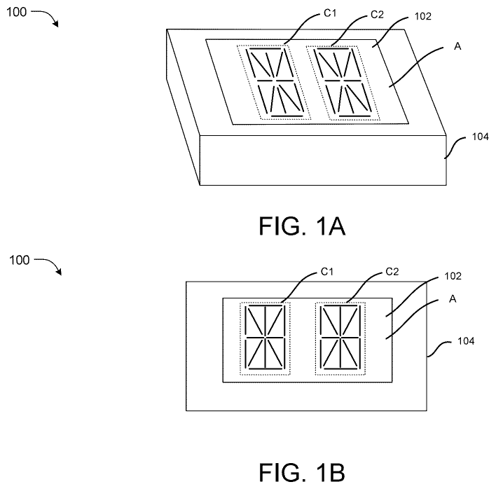

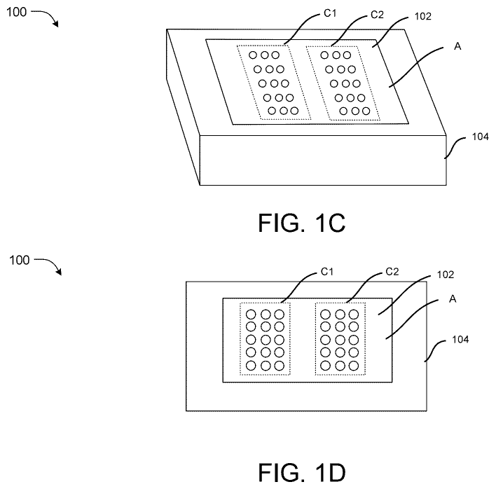

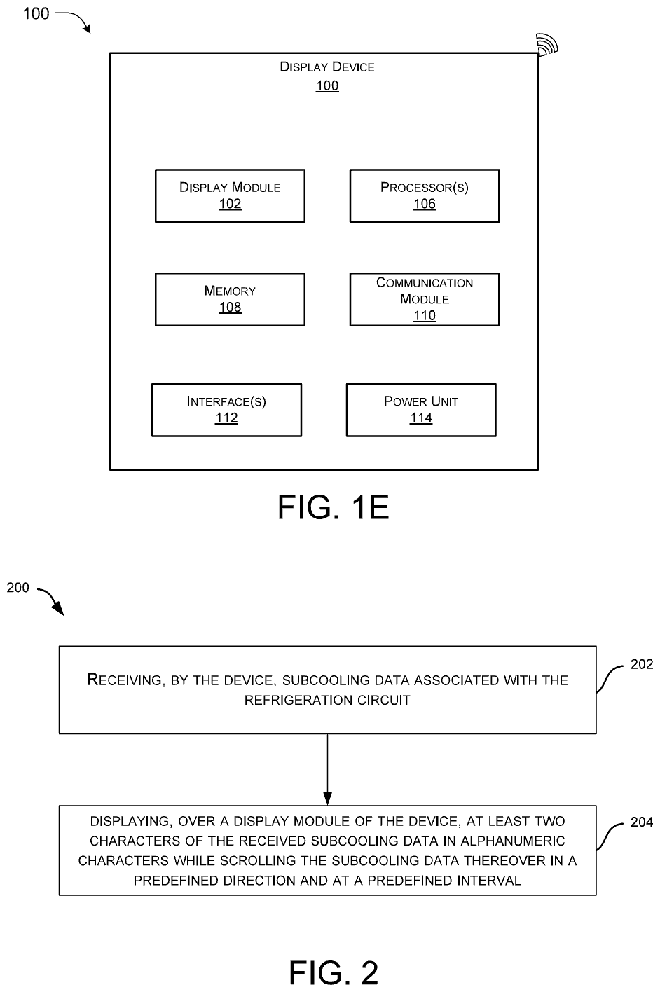

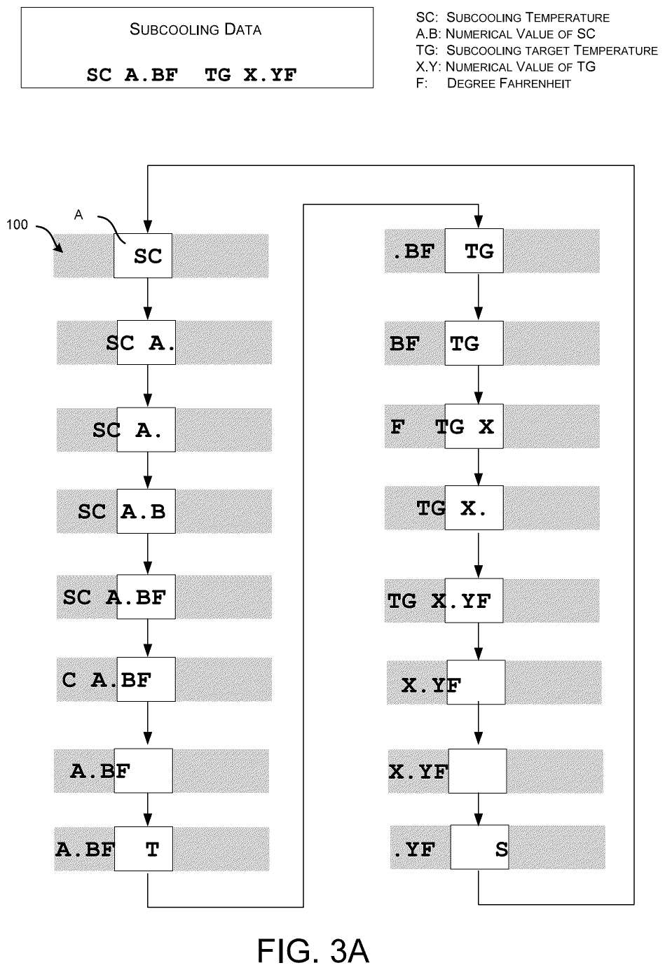

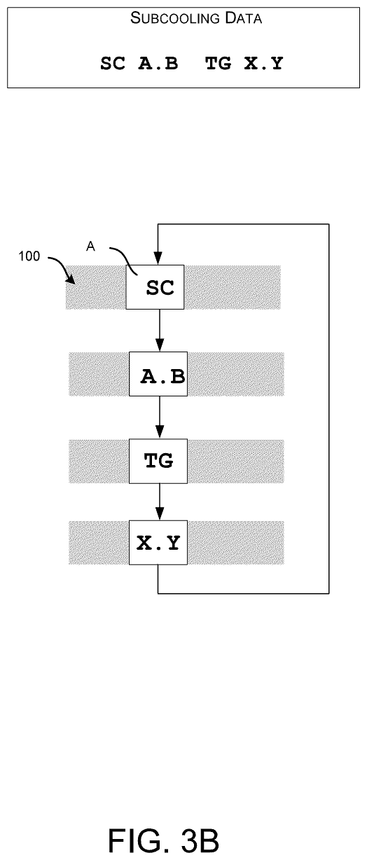

Referring to FIGS. 1A to 1E, a device 100 for displaying subcooling data of a refrigeration circuit associated with an HVAC system (not shown) is disclosed. The device 100 may include a display module 102 having a predefined display area (A) that may be configured to display at least two characters (C1, C2) at a time. The characters may include alphanumeric characters comprising alphabets (A-Z) and numbers (0-9), and string characters comprising punctuation mark, decimal point, period, colon, semi-colon, bracket, curly bracket, parentheses, hyphen, dash, and the like. The device 100 may be configured to receive subcooling data of the refrigeration circuit and display the received subcooling data over the display area (A) in alphanumeric and/or string characters while scrolling or paging the data thereover in a predefined direction and at a predefined interval. In one or more embodiments, the device 100 may be configured to display two alphanumeric and/or string characters associated with the subcooling data over the display area (A) at a time while scrolling the data in a predefined direction and at the predefined interval. The detailed way of displaying and scrolling the subcooling data over the display area (A) of the device 100 has been described later in conjunction with FIG. 3A. Further, in one or more embodiments, the device 100 may be configured to display two alphanumeric and/or string characters associated with the subcooling data over the display area (A) at a time while paging a series of the two characters of the data one at a time (without scrolling) in a predefined direction at the predefined interval. The detailed way of displaying and paging the subcooling data over the display area (A) of the device 100 has been described later in conjunction with FIG. 3B. In one or more embodiments, the subcooling data may include, but is not limited to, a subcooling temperature of refrigerant within the refrigeration circuit, and a subcooling target temperature to be maintained in a vapor line of the refrigeration circuit.

In one or more embodiments, the display module 102 may be a LED-based display that may be configured to display two alphanumeric and/or string characters at a time. In such embodiments, the display module 102 may include two sets of 14-segment displays (also designated as C1, C2) as shown in FIGS. 1A and 1B, where each 14-segment display may display one of the two alphanumeric and/or string characters. In one or more embodiments, the display module 102 may also include one 14-segment display capable of displaying two alphanumeric and/or string characters at a time. Further, in one or more embodiments, the display module 102 may be a dot-matrix display that may be configured to display two alphanumeric and/or string characters at a time. In such embodiments, the display module 102 may include two sets of 3×5 dot-matrix displays (also designated as C1, C2) separated by a blank space as shown in FIGS. 1C and 1D, where each 3×5 dot-matrix display may display one of the two alphanumeric and/or string characters. In one or more embodiments, the display module 102 may also be a single 5×7 dot-matrix display in landscape format capable of displaying two alphanumeric and/or string characters at a time. In such embodiments, each character C1, C2 is displayed on two 3×5 areas of the 5×7 display, being separated by a blank column. Furthermore, in one or more embodiments, the display module 102 may be a liquid crystal display (LCD), and an e-ink display having the display area (A) configured to display two characters at a time.

In one or more embodiments, the display module 102 may be configured to be operably connected to a charge-setting monitoring unit (not shown) associated with the refrigeration circuit. In one or more embodiments, the charge-setting monitoring unit may be a computing device 100 such as, but not limited to, a thermostat or a refrigerant charging controller associated with the HVAC system. Further, in one or more embodiments, the charge-setting monitoring unit may be a computing device 100 associated with HVAC controls of the HVAC systems. Furthermore, in one or more embodiments, the charge-setting monitoring unit may be a separate computing device 100 capable of determining and generating the subcooling data. The charge-setting monitoring unit may be configured to determine the subcooling temperature of refrigerant within the refrigeration circuit, and the subcooling target temperature to be maintained in the vapor line of the refrigeration circuit, and correspondingly generate and transmit the subcooling data of the refrigeration circuit to the display device 100 in real-time.

Referring to FIG. 3A, an exemplary representation of the subcooling data being displayed and scrolled over the display area (A) of the device 100 is disclosed. In one or more embodiments, the subcooling data may be first converted into alphanumeric and/or string characters including, but not limited to, alphabets (A to Z), numbers (0 to 9), punctuation mark, decimal point, period, colon, semi-colon, brackets, curly brackets, parentheses, hyphen, and dash. This may help define and indicate the subcooling data over the display area (A) of the device 100 in the minimum number of characters and in an efficient and cost-effective way. For instance, in a non-limiting example, the subcooling temperature may be indicated as “SC” and the subcooling target temperature may be indicated as “TG.” Further, the SI unit of the subcooling temperature and subcooling target temperature may either be indicated in Fahrenheit or Celsius. For instance, in a non-limiting example, Fahrenheit may be indicated as “F” and Celsius may be indicated as “C.”

In one or more embodiments, the numerical value of the subcooling temperature may be indicated after the indicator “SC,” followed by the indicator “F” or “C” to indicate its SI unit. Further, the indicated subcooling temperature data may be followed by the subcooling target temperature where the numerical value of the subcooling target temperature may be indicated after the indicator “TG,” followed by the indicator “F” or “C” to indicate its SI unit. Furthermore, characters of the subcooling temperature data and the subcooling target temperature data may be separated by a space, comma, or colon therebetween, to indicate completion of displaying the subcooling temperature data. In a non-limiting example, as shown in FIG. 3A, the numerical value of the subcooling temperature is indicated as A.B and the numerical value of the subcooling target temperature is indicated as X.Y. Accordingly, the overall subcooling data received by the device 100 may be converted into alphanumeric and/or string characters that may be indicated as “SC A.BF TG X.YF”.

Further, this subcooling data “SC A.BF TG X.YF” indicating both the subcooling temperature and the subcooling target temperature, may be scrolled over the display area (A) such that only two characters remain visible at a time. The subcooling data “SC A.BF TG X.YF” may be scrolled in a predefined direction selected from left to right, top to bottom, but not limited to the like, over the display area (A) such that “SC” is indicated first followed by the numerical value “A.B” and the SI unit “F,” and then “ST” is indicated followed by the numerical value “X.Y” and the SI unit “F.” Once the overall subcooling data “SC A.BF TG X.YF” is scrolled over the display area (A), the indication of the subcooling data over the display area (A) may be repeated at a predefined interval, allowing users to read the overall subcooling data. In other embodiments (not shown), the subcooling target temperature (TG X.YF) may be first indicated followed by the subcooling temperature “SC A.BF”.

Referring to FIG. 3B, an exemplary representation of the subcooling data being displayed and paging over the display area (A) of the device 100 is disclosed. In such embodiments, this subcooling data “SC A.BF TG X.YF” indicating both the subcooling temperature and the subcooling target temperature, may be paged over the display area (A) as “SC A.B TG X.Y” such that a series of two characters associated with the data “SC A.B TG X.Y” remain visible one at a time without scrolling the data. The subcooling data “SC A.B TG X.Y” may be paged or displayed over the display area (A) such that “SC” is indicated first for a given time followed by displaying the numerical value “A.B”. Further, “TG” is indicated followed by the numerical value “A.B”. Once all the characters of the overall subcooling data “SC A.B TG X.Y” are paged or displayed over the display area (A), the indication of the subcooling data over the display area (A) may be repeated at a predefined interval, allowing the users to read the overall subcooling data. In other embodiments, the subcooling target temperature (TG X.Y) may be first indicated followed by the subcooling temperature “SC A.B”.

It is to be appreciated by a person skilled in the art that as the overall subcooling data (subcooling temperature and subcooling target temperature) is scrolled or paged over the display area (A) in just two characters (C1, C2) at a time, the display module 102 selected for the device 100 may be kept smaller (displaying only two characters). This may lower the power consumption and cost of the display module 102, thereby making the device 100 simple, efficient, and cost-effective. Further, it is to be appreciated by a person skilled in the art that the subcooling data indicated in FIGS. 3A and 3B is only exemplary, and the data can be changed to other data without any limitation whatsoever, and all such implementations are well within the scope of the subject disclosure.

Referring to FIG. 1E, in one or more embodiments, the device 100 may include one or more processors 106 coupled to a memory 108 storing instructions executable by the processor 106 which may cause the device 100 to perform one or more designated operations including, but not limited to, receiving the subcooling data, converting the subcooling data into alphanumeric and/or string characters, displaying the alphanumeric and/or string characters associated with the subcooling data over the display area (A) of the display module 102, and scrolling or paging the displayed alphanumeric and/or string characters in the predefined direction and at the predefined interval over the display area (A).

In one or more embodiments, the device 100 may include a communication module 110 that may be configured to enable the device 100 to establish a communication channel with a charge-setting monitoring unit or a thermostat or refrigerant charging controller associated with the HVAC system.

In one or more embodiments, the processors 106 may be implemented as one or more microprocessors, microcomputers, microcontrollers, digital signal processors, central processing units, logic circuitries, and/or any devices that manipulate data based on operational instructions. Among other capabilities, the processors 106 are configured to fetch and execute computer-readable instructions stored in the memory 108. The memory 108 may store one or more computer-readable instructions or routines, which may be fetched and executed to create or share the data units over a network service. The memory 108 may comprise any non-transitory storage device including, for example, volatile memory such as RAM, or non-volatile memory such as EPROM, flash memory, and the like.

In addition, the device 100 may include an in-built battery (not shown) electrically connected to the components of the device 100 to power the device 100. Further, the device 100 may be configured to be electrically connected to an external power source (not shown) to supply electrical power for powering the device 100 and/or for charging the battery. The device 100 may include a power unit 114 configured with the battery or components of the device 100 to control the supply of electrical power from the battery or the external power source to different components of the device 100 while keeping the components of the device 100 safe from electrical failures.

The device 100 may also comprise an interface(s) 112 that may comprise a variety of interfaces, for example, interfaces for the charge-setting monitoring unit, the HVAC system, and the like. In one or more embodiments, the communication module 110 of the device 100 may be a Wi-Fi module, transceiver, Bluetooth module, cellular connection modules such as 2G, 3G, 4G, and 5G, and the like to facilitate communication of the device 100 with the charge-setting monitoring unit, the HVAC system, and mobile devices associated with users, through a network. Further, the communication module 110 may enable the device 100 to be operably connected to the charge-setting monitoring unit and/or the HVAC system via wired media. The interface(s) 112 may also provide a communication pathway for the internal components or units of the device 100. Examples of such internal components include, but are not limited to, the display module 102, the battery, and the power unit 114.

In one or more embodiments, the components of the device 100 may be secured or enclosed within a housing (shown in FIGS. 1A-1D) or an enclosure 104, such that the display area (A) of the display module 102 remains visible from outside of the device 100. Further, in one or more embodiments, the housing or enclosure 104 of the device 100 may be configured to be removably or fixedly installed or secured at one or more locations by the users. In one or more embodiments, the housing or enclosure 104 may be provided with one or more fixtures to facilitate securing the device 100 at the one or more locations. For instance, in one or more embodiments, the device 100 may be secured on an outdoor unit or refrigerant charging controller or control board associated with the HVAC system. This may allow the users to easily access and view the displayed subcooling data while charging the refrigeration circuit. Further, in one or more embodiments, the device 100 may be secured on the thermostat associated with the HVAC system. Furthermore, in one or more embodiments, the device 100 may also be secured on or may be a part of the charge-setting monitoring unit. In one or more other embodiments, the device 100 may be secured in an area of interest or a space where the HVAC system is installed.

Referring to FIG. 2, method 200 for displaying subcooling data of a refrigeration circuit associated with an HVAC system is disclosed. The method 200 may involve the device 100, and the charge-setting monitoring unit or thermostat associated with the HVAC system. Method 200 may include step 202 of receiving, by the device 100. the subcooling data associated with the refrigeration circuit from the charge-setting monitoring unit. The subcooling data may include one or more of the subcooling temperature of refrigerant within the refrigeration circuit, and a subcooling target temperature to be maintained in a vapor line of the refrigeration circuit. Method 200 may further include step 204 of displaying, over a display module of the device, the received subcooling data of the refrigeration circuit in alphanumeric and/or string characters while scrolling or paging the subcooling data thereover in a predefined direction and at a predefined interval.

While various embodiments and drawings have been described herein for displaying the subcooling temperature of the refrigerant, and the subcooling target temperature associated with the refrigeration circuit, however, the device 100 may also be configured to display other data associated with the HVAC system, including but not limited to, temperature and pressure of the refrigerant at various locations in the refrigeration circuit, indoor temperature and humidity in an area where the HVAC system is installed, and outdoor temperature and humidity among various other data, and all such embodiments are well within the scope of the subject disclosure.

Thus, the subject disclosure (device and method) may provide a solution to accurately display subcooling data associated with the HVAC system. The subject disclosure ensures accurate assessment and display of the HVAC system's refrigerant charge or subcooling data in a simple, efficient, and cost-effective way while eliminating any potential for contamination and preventing the release of refrigerants into the atmosphere. As the overall subcooling data (subcooling temperature and subcooling target temperature) is scrolled or paged over the display area of the device in just two characters at a time, the display module 102 selected for the device 100 may be kept smaller which may be capable of displaying only two characters. This may lower the power consumption and cost of the display module 102, thereby making the device 100 simple, efficient, and cost-effective

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adapt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A device for displaying subcooling data of a refrigeration circuit associated with an HVAC system, the device comprising:
a display module having a predefined display area configured to display at least two characters at a time, wherein the display module is configured to:
receive subcooling data of the refrigeration circuit; and
display the received subcooling data over the predefined display area in alphanumeric and/or string characters at a predefined interval.

2. The device of claim 1, wherein the subcooling data comprises one or more of a subcooling temperature of refrigerant within the refrigeration circuit, and a subcooling target temperature to be maintained in a vapor line of the refrigeration circuit.

3. The device of claim 1, wherein the predefined display area of the display module is configured to display two alphanumeric and/or string characters at a time.

4. The device of claim 1, wherein the device is configured to display two alphanumeric and/or string characters associated with the subcooling data over the predefined display area at a time while scrolling the data in a predefined direction and at the predefined interval.

5. The device of claim 1, wherein the device is configured to display two alphanumeric and/or string characters associated with the subcooling data over the predefined display area at a time while paging a series of the two characters of the data in a predefined direction at the predefined interval.

6. The device of claim 1, wherein the device is secured on an outdoor unit associated with the HVAC system.

7. The device of claim 1, wherein the device is secured on a thermostat associated with the HVAC system.

8. The device of claim 1, wherein the display module is configured to be operably connected to a charge-setting monitoring unit associated with the refrigeration circuit, and wherein the charge-setting monitoring unit is configured to generate the subcooling data of the refrigeration circuit.

9. The device of claim 8, wherein the device is secured on the charge-setting monitoring unit.

10. The device of claim 1, wherein the display module is a dot-matrix display.

11. The device of claim 10, wherein the display module is a 5×7 dot-matrix display.

12. The device of claim 1, wherein the display module is selected from a group comprising a light-emitting diode (LED) based display, a liquid crystal display (LCD), and an e-ink display.

13. The device of claim 1, wherein the device further comprises a communication module configured to enable the device to establish a communication channel with a charge-setting monitoring unit or a thermostat associated with the HVAC system.

14. The device of claim 1, wherein the device further comprises a battery that provides electrical power to the device.

15. The device of claim 1, wherein the device is configured to be electrically connected to an external power source to supply electrical power to the device and/or charge a battery.

16. A method for displaying subcooling data of a refrigeration circuit associated with an HVAC system, the method comprising:
displaying, over a display module having a predefined display area configured to display at least two characters at a time, subcooling data of the refrigeration circuit in alphanumeric and/or string characters at a predefined interval.

17. The method of claim 16, wherein the subcooling data comprises one or more of a subcooling temperature of refrigerant within the refrigeration circuit, and a subcooling target temperature to be maintained in a vapor line of the refrigeration circuit.

18. The method of claim 16, wherein the method further comprises displaying, over the predefined display area, two alphanumeric and/or string characters associated with the subcooling data at a time while scrolling the data in a predefined direction and at the predefined interval.

19. The method of claim 16, wherein the method further comprises displaying, over the predefined display area, two alphanumeric and/or string characters associated with the subcooling data at a time while paging a series of the two characters of the data in a predefined direction at the predefined interval.

20. The method of claim 16, wherein the display module is secured on one or more of an outdoor unit, a thermostat, and a charge-setting monitoring unit associated with the HVAC system, and wherein the display module is selected from a group comprising a light-emitting diode (LED) based display, a liquid crystal display (LCD), an e-ink display, and a dot-matrix display.
